(19) United States
(12) Patent Application Publication
(10) Pub. No.: US 2008/0243425 A1
(43) Pub. Date: Oct. 2, 2008

(54) Tracking target objects through occlusions

(76) Inventor: Austin I. D. Eliazar, Morrisville, NC (US)

Correspondence Address: SUGHRUE MION, PLLC, 2100 PENNSYLVANIA AVENUE, N.W., SUITE 800, WASHINGTON, DC, 20037, US

(21) Appl. No.: 11/808,941

(22) Filed: Jun. 14, 2007

Related U.S. Application Data
(63) Continuation-in-part of application No. 11/727,668, filed on Mar. 28, 2007.

(51) Int. Cl. G06F 15/00

(52) U.S. Cl. 702/150

(57) ABSTRACT

A computerized object tracking method uses data captured from any of a number of sensor suites deployed in an area of interest to identify and track objects of interest within the area covered by the sensors. Objects of interest are uniquely identified utilizing an ellipse-based model and tracked through complex data sets through the use of particle-filtering techniques. The combination of unique object identification and particle-filtering techniques produces the ability to track any of a number of objects of interest through complex scenes, even when the objects of interest are occluded by other objects within the dataset. The tracking action is presented in real-time to a user of the system and accepts direction and requests from the system user.

This application is a Continuation-in-part of co-pending application Ser. No. 11/727,668 which was filed Mar. 28, 2007, and which is incorporated by reference.

### COPYRIGHT NOTICE

A portion of the disclosure of this patent document contains material which is subject to copyright protection. The copyright owner has no objection to the facsimile reproduction of the patent document or the patent disclosure, as it appears in the Patent and Trademark Office patent file or records, but otherwise reserves all copyright rights whatsoever.

### BACKGROUND OF THE INVENTION

The pages that follow describe experimental work, presentations and progress reports that disclose currently preferred embodiments consistent with the above-entitled invention. All of these documents form a part of this disclosure and are fully incorporated by reference. This description incorporates many details and specifications that are not intended to limit the scope of protection of any utility patent application which might be filed in the future based upon this provisional application. Rather, it is intended to describe an illustrative example with specific requirements associated with that example. Therefore, the description that follows should only be considered as exemplary of the many possible embodiments and broad scope of the present invention. Those skilled in the art will appreciate the many advantages and variations possible on consideration of the following description.

### BRIEF DESCRIPTION OF THE DRAWINGS

FIG. 1: system diagram for the Tracking through Occlusions system design

FIG. 2: view of the formation of an object centroid for tracking

FIG. 3: process flow for tracking method

### DETAILED DESCRIPTION OF THE INVENTION

When constructing a system for tracking atomic objects within an environment, it is critical that the descriptive definition for an object is clearly defined. In a video sequence, a person can appear in the scene carrying a bag. It is not immediately apparent whether the correct behavior is to treat the bag as a separate object from the person. For our purposes, we have chosen a functional definition for objects, considering any group of pixels which tends to move as a group to be a single object. In our example case, if the motion of the bag were sufficiently distinguished from that of the person, it would be treated as a separate entity. This effectively groups together pixels which maintain a strong spatial dependence over time, and tracks them as a whole.

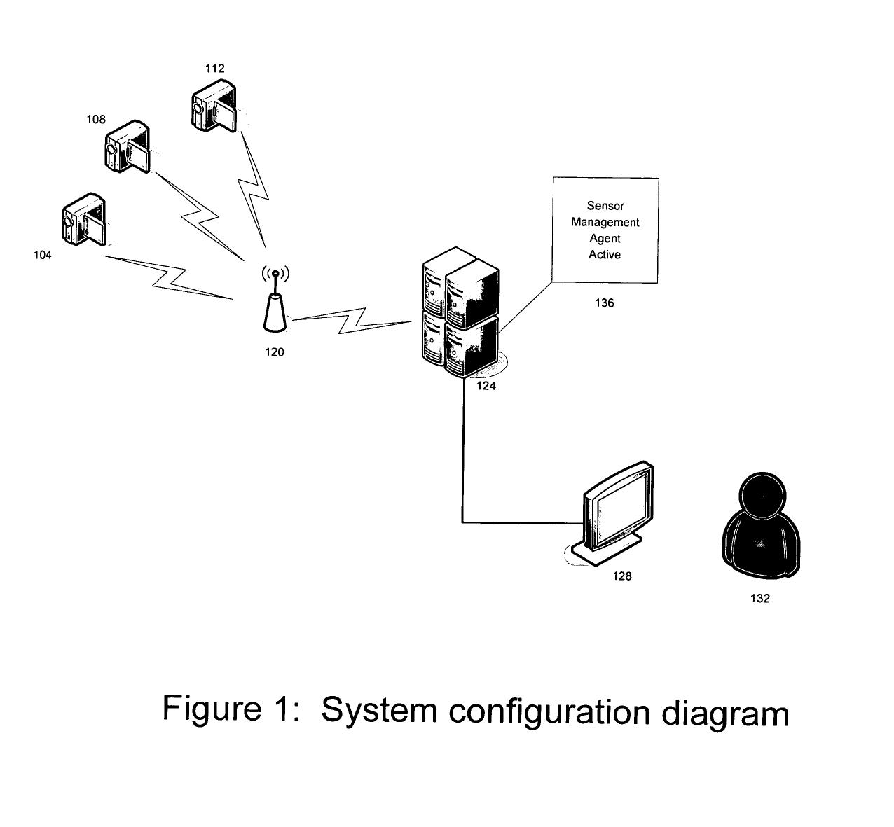

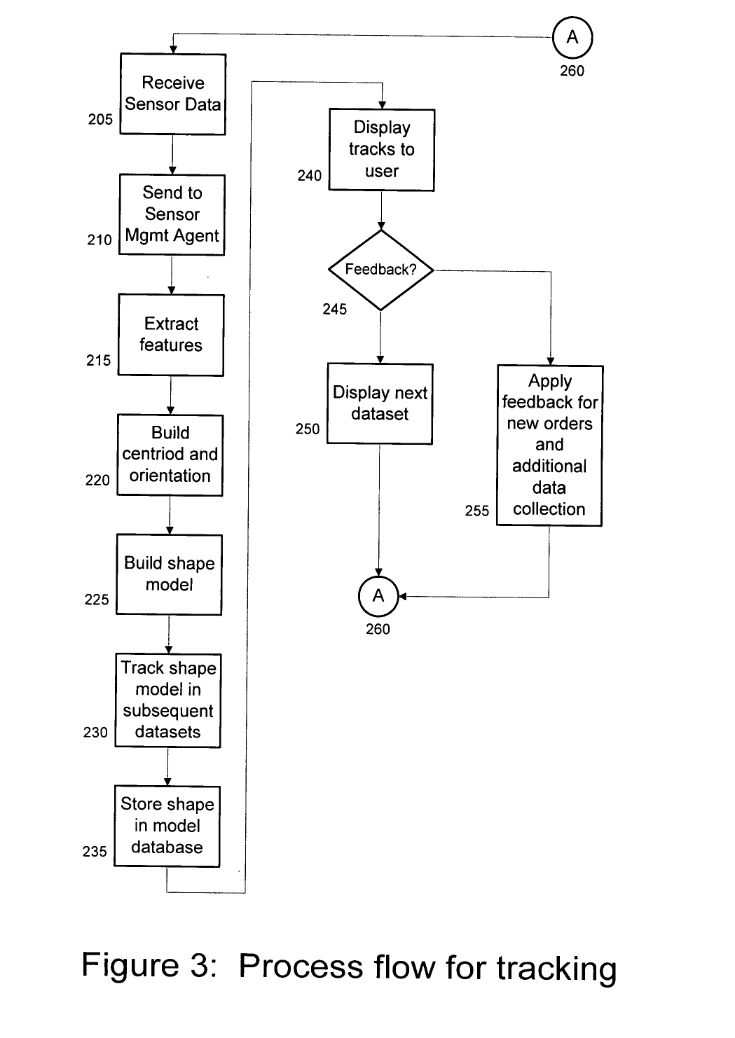

Regarding FIG. 1, this is a view of the system with a plurality of sensors (104, 108, 112) deployed in the field and collecting data in real time under instruction from the Sensor Management Agent (SMA) 136 installed in a system processor 124. The SMA 136 uses a variety of means to communicate with the sensors (104, for example) in the field, including wired network connection, wireless connection points 120, satellite relay, radio, GPS, and any other means for providing data communication from a sensor to an end point. When the SMA 136 receives the sensor (104, 108, 112) data, the SMA 136 performs tracking operations (See FIG. 3) and sends the results to a display device, such as a monitor in an exemplary embodiment 128, for presentation to a user 132. The user 132 may then provide feedback to the SMA 136 regarding new data collection efforts or object classification.

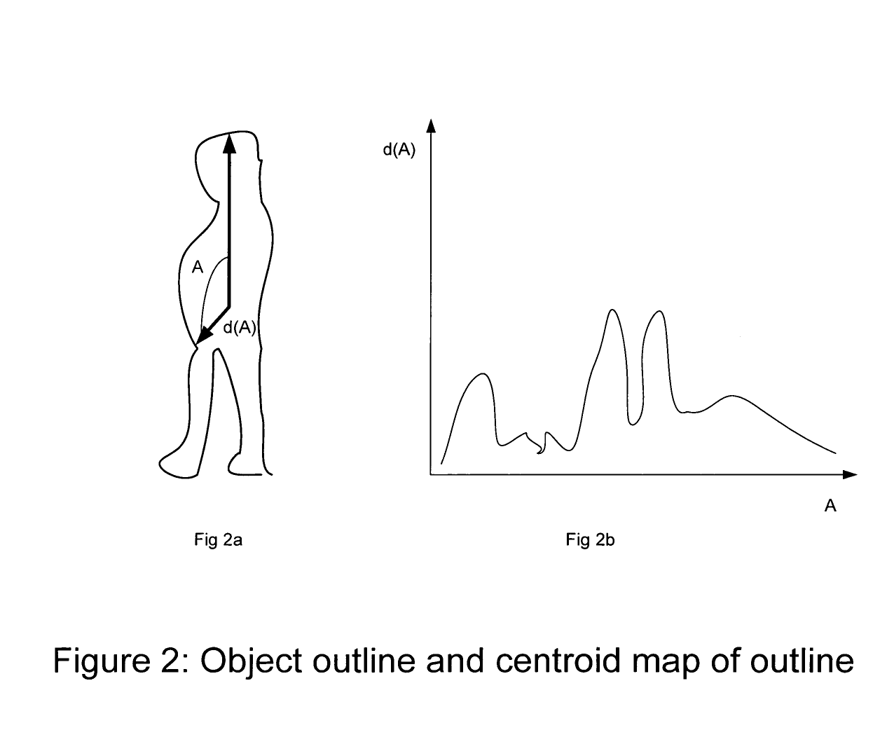

Regarding FIG. 2, an exemplary embodiment is presented for one view of data objects that are processed by the SMA 136. In the exemplary embodiment a silhouette is formed from associated data within the collected data set (FIG. 2a). This silhouette may form the outline shape of an object of interest as defined within the SMA 136. The SMA 136 then produces a shape model formed of the data pixels that represent the silhouette (FIG. 2a) and the angle and distance of each data pixel from the centroid of the shape silhouette data (FIG. 2b).

The primary purpose of the shape model is to capture this spatial dependency between pixels corresponding to the same object. This not only allows the creation of data association, finding the component pixels of an object to update the models, but it also provides a strong predictive power for the set of assignments within a specific region of the image, when the object's location is known. Therefore, computing the probability of a set of assignments, A, when provided with an object's shape model, C, and its current position, μ: p(A|S,μ) is easily accomplished.

A novel method of modeling of representing these spatial dependencies has been developed, using a dynamic type of stochastic occupancy grid. A template grid, corresponding to individual pixels, is maintained for each object, centered on an arbitrary point of reference. Each grid cell contains a predictive probability that a pixel will be observed at that given position. An autoregressive model is used to update this probability estimate, based on the observed behavior. If, in an exemplary embodiment, an object is designated as a person-shaped object, the stochastic nature of this model allows more mobile sections of the object, such as a person's limbs, to be modeled as an area of more diffuse probability, while the more stable areas, such as a person's head and torso, to maintain a more certain and clearly delineated model. Also, persistent changes in the shape of an object, for example, when a car turns in its orientation, are easily accommodated for, as the auto-regression allows more recent information to outweigh older, perhaps outdated, evidence. One of the strengths of this approach to object shape estimation is the invariance to object-sensor distance and the flexibility to describe multiple types of objects (people, vehicles, people on horses, or any object of interest).

This novel method of stochastic shape modeling provides a seamless and effective method which can handle occlusions and color ambiguity. Occlusions occur when: objects of interest overlap (dynamic occlusions), objects of interest pass behind a background object (static occlusion), or objects deform to overlap (self occlusions). Color ambiguity may occur when objects and background pixels are similar in color intensities, resulting high background likelihood values for these pixels. To address these issues, a detailed set of object assignments are used, where each label consists of background or a set of objects. Thus a single pixel can be labeled with multiple object IDs, as we undergo a dynamic occlusion. This method has proven effective in dealing with complex scenes and can seamlessly handle additional evidence and models in the future.

In another exemplary embodiment, cameras may be used as remote sensors for gathering video and audio data sets for use in tracking. Regarding nonlinear object ID and tracking methods, the objects within a scene are characterized via a feature-based representation of each object. Kalman filtering and particles filters have been implemented to track object position and velocity through a video sequence. A point of reference for each object (e.g. center of mass) is tracked through video sequence. Given an adequate frame rate, greater than 3 frames per second, we can assume that this motion is approximately linear. Kalman filters provide a closed form solution to track the position and velocity of an object, given Gaussian noise, and produce a full probability distribution for the given objects in the scene.

An objective in this exemplary embodiment is to track level-set-derived target silhouettes through occlusions, caused by moving objects going through one another in the video. A particle filter is used to estimate the conditional probability distribution of the contour of the objects at time τ, conditioned on observations up to time τ. The video/data evolution time τ should be contrasted with the time-evolution t of the level-sets, the later yielding the target silhouette (FIG. 1).

The algorithm used for tracking objects during occlusions consists of a particle filtering framework that uses level-sets results for each update step.

This technique will allow the inventive system to track moving people during occlusions. In occlusion scenarios, using just the level sets algorithm would fail to detect the boundaries of the moving objects. Using particle filtering, we get an estimate of the state for the next moment in time p(X_{τ}|Y_{1:τ-1}), update the state

$$p ( {X}_{τ} \vert {Y}_{1 : τ} ) \approx {\sum }_{i = 1}^{N} \frac{1}{N} {δ}_{{X}_{τ}^{( i )}} ( dx ) ,$$

and then use level sets for only a few iterations, to update the image contour γ(τ+1). With this algorithm, objects are tracked through occlusions and the system is capable of approximating the silhouette of the occluded objects.

Regarding FIG. 3, this figure presents the process for the gathering of sensor data within the exemplary embodiment presented previously. Sensor data from the distributed sensors (104, 108, 112) is gathered and received into the system 205. The data is collected into a structured data set and sent 210 to the SMA 136. The SMA 136 utilizes conditions and instructions on objects of interest to extract the features 215 for all objects that may be of interested based upon the conditions and instructions operative within the SMA 136. A process within the SMA 136 reviews the object data, calculates the centroid of the object in question (FIG. 2a), and calculates pixel orientation and distance (FIG. 2b) from the centroid 220. From this calculated data the SMA then builds a shape model 225 for all identified objects of interest. The SMA then performs tracking functions on the incoming data sets 230 to determine the traces of all identified objects through the incoming data sets as collected by the sensors (104, 108, 112). The calculated data and all tracking data are stored within a computer storage medium in the form of a database 235. The data is also displayed on a device capable of presenting the calculated and tracking data in such a manner as to be viewed and understood by a Human user 240, such as a video display device 128. The user is provided with the opportunity to present feedback, in the form of instructions for additional data collection or identifying new objects of interest 245. The SMA 136 receives this feedback and operates to order additional data collection and update the listing of objects of interest within its own instruction data base 255.

While certain illustrative embodiments have been described, it is evident that many alternatives, modifications, permutations and variations will become apparent to those skilled in the art in light of the description.

We claim:

1. A method for identifying and extracting objects from a set of captured sensor data and tracking such objects through subsequent captured data sets comprising:
receiving captured data from a suite of sensors deployed in physical area of interest;
extracting the features of an object of interest from said captured sensor data;
fitting the extracted features together to form an orientation and a centroid for each object of interest that is to be tracked;
building a shape model for each object of interest to be tracked;
tracking each said object shape model across subsequent captured sensor dataset;
recording said tracking and object shape model data in a computer readable medium.
presenting said tracking information to a user to provide real time location within each set of sensor data;
accepting feedback data from said user in the form of object prioritization and orders for additional object identification;
wherein said tracking location information may be used to continuously observe the identity and position of each of said objects of interest even when occluded by other objects or features within said captured sensor data.

2. A method as in claim 1 for identifying and extracting objects from a set of captured sensor data and tracking such objects through subsequent captured data sets further comprising:
said suite of sensors may be comprised of audio, video, infrared, radar, UV, lowlight, xray, particle-emission, vibration, or any other sensors the data from which may be used to fix the location of objects within a medium.

3. A method as in claim 1 for identifying and extracting objects from a set of captured sensor data and tracking such objects through subsequent captured data sets further comprising:
wherein extracting the features of an object of interest comprises using an ellipse based model which forms an ellipse for each region of an object of interest.

4. A method as in claim 1 for identifying and extracting objects from a set of captured sensor data and tracking such objects through subsequent captured data sets further comprising:
wherein fitting the object features together comprises identifying the orientation of each ellipse and locating the centroid of said object of interest and storing this data into the profile of said object of interest.

5. A method as in claim 1 for identifying and extracting objects from a set of captured sensor data and tracking such objects through subsequent captured data sets further comprising:
wherein the shape model for each object comprises at least the values of each ellipse, ellipse orientation, centroid, direction of motion, and the atomic sensor data that composes each object.

6. A method as in claim 1 for identifying and extracting objects from a set of captured sensor data and tracking such objects through subsequent captured data sets further comprising:
tracking comprises the collection of shape model data for each of said objects of interest from each set of collected sensor data and linking them together in a timed sequence;
wherein said tracking information is presented to a user of the system for real time use or subsequent analysis.

7. A method as in claim 1 for identifying and extracting objects from a set of captured sensor data and tracking such objects through subsequent captured data sets further comprising:
presenting real time location information to a user in the form of video, audio, text, metadata, or any custom format that will allow said user to follow any changes in location for each object of interest being tracked.

8. A method as in claim 1 for identifying and extracting objects from a set of captured sensor data and tracking such objects through subsequent captured data sets further comprising:
wherein said feedback data from a user comprises directions for operating the tracking function and requests for additional sensor data collection.

9. A computer program product embodied in a computer readable medium for identifying and extracting objects from a set of captured sensor data and tracking such objects through subsequent captured data sets comprising:
receiving captured data from a suite of sensors deployed in physical area of interest;
extracting the features of an object of interest from said captured sensor data;
fitting the extracted features together to form an orientation and a centroid for each object of interest that is to be tracked;
building a shape model for each object of interest to be tracked;
tracking each said object shape model across subsequent captured sensor dataset;
recording said tracking and object shape model data in a computer readable medium.
presenting said tracking information to a user to provide real time location within each set of sensor data;
accepting feedback data from said user in the form of object prioritization and orders for additional object identification;
wherein said tracking location information may be used to continuously observe the identity and position of each of said objects of interest even when occluded by other objects or features within said captured sensor data.

10. A computer program product embodied in a computer readable medium as in claim 9 for identifying and extracting objects from a set of captured sensor data and tracking such objects through subsequent captured data sets further comprising:
said suite of sensors may be comprised of audio, video, infrared, radar, UV, lowlight, xray, particle-emission, vibration, or any other sensors the data from which may be used to fix the location of objects within a medium.

11. A computer program product embodied in a computer readable medium as in claim 9 for identifying and extracting objects from a set of captured sensor data and tracking such objects through subsequent captured data sets further comprising:
wherein extracting the features of an object of interest comprises using an ellipse based model which forms an ellipse for each region of an object of interest.

12. A computer program product embodied in a computer readable medium as in claim 9 for identifying and extracting objects from a set of captured sensor data and tracking such objects through subsequent captured data sets further comprising:
wherein fitting the object features together comprises identifying the orientation of each ellipse and locating the centroid of said object of interest and storing this data into the profile of said object of interest.

13. A computer program product embodied in a computer readable medium as in claim 9 for identifying and extracting objects from a set of captured sensor data and tracking such objects through subsequent captured data sets further comprising:
wherein the shape model for each object comprises at least the values of each ellipse, ellipse orientation, centroid, direction of motion, and the atomic sensor data that composes each object.

14. A computer program product embodied in a computer readable medium as in claim 9 for identifying and extracting objects from a set of captured sensor data and tracking such objects through subsequent captured data sets further comprising:
tracking comprises the collection of shape model data for each of said objects of interest from each set of collected sensor data and linking them together in a timed sequence;
wherein said tracking information is presented to a user of the system for real time use or subsequent analysis.

15. A computer program product embodied in a computer readable medium as in claim 9 for identifying and extracting objects from a set of captured sensor data and tracking such objects through subsequent captured data sets further comprising:
presenting real time location information to a user in the form of video, audio, text, metadata, or any custom format that will allow said user to follow any changes in location for each object of interest being tracked.

16. A computer program product embodied in a computer readable medium as in claim 9 for identifying and extracting objects from a set of captured sensor data and tracking such objects through subsequent captured data sets further comprising:
wherein said feedback data from a user comprises directions for operating the tracking function and requests for additional sensor data collection.
